(19) United States
(12) Patent Application Publication
(10) Pub. No.: US 2017/0297582 A1
(43) Pub. Date: Oct. 19, 2017

(54) TOUCH-LESS MONITORING OF OPERATORS IN VEHICLES AND OTHER SETTINGS

(71) Applicant: VitalMetric, LLC, Waunakee, WI (US)

(72) Inventors: Michael Rosing, Madison, WI (US); David Reid, Hazel Green, WI (US); James F. McCain, Houston, TX (US); Dennis Dynneson, Waunakee, WI (US)

(21) Appl. No.: 15/491,812

(22) Filed: Apr. 19, 2017

Related U.S. Application Data
(60) Provisional application No. 62/324,368, filed on Apr. 19, 2016.

(51) Int. Cl. B60W 40/08

(52) U.S. Cl. CPC B60W 40/08; B60W 2040/0818

(57) ABSTRACT

Embodiments of the invention provide a system and a method for monitoring alertness of an operator. At least one continuous wave radar device can be used to detect an indicator of a biological parameter for the operator. A value for the biological parameter can be determined based upon the detected indicator. A level of alertness of the operator can be determined based upon the determined value for the biological parameter.

### BACKGROUND

In many settings, it may be useful to monitor operators for indicators of the ability to appropriately function in a particular role. For example, in the context of commercial vehicle transport operations, a lack of alertness by an operator of the relevant vehicle (e.g., a tractor-trailer truck, delivery van, or similar other vehicle) can result in operator errors, including accidental impacts involving the vehicle or other adverse events. Operator alertness can also be important in many other settings.

### SUMMARY

Some embodiments of the invention provide a system for monitoring alertness of an operator. At least one radar device can be configured to detect an indicator of a biological parameter for the operator. One or more controllers can be in communication with the radar device. The one or more controllers can be configured to determine a value for the biological parameter based upon the detected indicator, and to determine a level of alertness of the operator based upon the determined value for the biological parameter.

Some embodiments of the invention provide a method for monitoring alertness of an operator. The method can include detecting, with at least one radar device, an indicator of a biological parameter for the operator. A value for the biological parameter can be determined, with one or more computing devices, based upon the detected indicator. A level of alertness of the operator can be determined, with the one or more computing devices, based upon the determined value for the biological parameter.

Some embodiments of the invention provide a monitoring device for touch-less monitoring of alertness of an operator. The monitoring device can include a communication interface in communication with one or more systems external to the monitoring device, and one or more controllers in communication with the radar device and the communication interface. The one or more controllers can be configured to determine a value for the biological parameter based upon the detected indicator, and to determine a level of alertness of the operator based upon the determined value for the biological parameter.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1A is perspective view of an tractor-trailer truck with which a monitoring system according to one embodiment of the invention can be used;

FIG. 1B is a side elevation view of aspects of a cab of the tractor-trailer truck of FIG. 1A, including an operator of the tractor-trailer truck and aspects of the monitoring system;

FIG. 2 is a side elevation view of aspects of a control room with which a monitoring system according to one embodiment of the invention can be used; and

FIG. 3 is a schematic view of a monitoring device for use with the systems of FIGS. 1B or FIG. 2;

FIG. 4 is a graph of test data relating pulse and fatigue;

FIG. 5 is an algorithm for performing the system and method herein; and

FIG. 6 is a schematic for performing the system and method herein.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise specified or limited, the phrases “at least one of A, B, and C,” “one or more of A, B, and C,” and the like, are meant to indicate A, or B, or C, or any combination of A, B, and/or C, including combinations with multiple instances of A, B, and/or C and combinations with individual instances of A, B, and/or C.

Also as used herein, unless otherwise specified or limited, electronic components specified as being in “communication” with each other can be in communication directly (e.g., wirelessly or via wired connections) or indirectly (e.g., via an intermediary communication device). Further, it will be understood that separate components configured to exchange information (e.g., electrical signals) with each other can be viewed as being in “communication” with each other even if the components are both included in a single larger device.

Also as used herein, unless otherwise limited or defined, an indicator relating to “alertness” (or the like) generally relates to whether or not a particular operator is sufficiently attentive or otherwise mentally or physically engaged to appropriately conduct a particular operation. For example, an indicator of whether an operator is “alert” may include an indicator of whether an operator is asleep or dozing, is in the process of falling asleep, such that the operator would no longer be able to operate a particular vehicle, machine, monitoring or control station, and so on.

Also as used herein, unless otherwise specified or limited, the term “operator” refers to a human operator of a particular vehicle, machine, system or device. In some cases, an operator can be in physical proximity to the vehicle, machine, system or device to be operated. In some cases, an operator can be remotely disposed relative to the vehicle, machine, system or device to be operated and can exert operational control via one or more control systems configured to function over appropriate distances.

Similarly, as used herein, unless otherwise specified or limited, the term “operate” can refer to passive or active operation of a relevant system. For example, an operator of a vehicle can operate the vehicle by actively driving or otherwise actively controlling movement of the vehicle. In contrast, an operator of a monitoring station for a power plant or other industrial installation can operate the monitoring station by paying adequate attention to relevant indicators provided by the monitoring station, which may not necessarily require affirmative actions to control the monitoring station or the installation that it is configured to monitor.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Generally, embodiments of the invention disclosed herein can utilize touch-less monitoring of biological parameters as a basis for determining whether a human operator is sufficiently alert to appropriately manage the tasks before him. For example, a touch-less monitoring system can be configured to monitor biological parameters such as pulse and respiration rate and analyze those parameters to determine whether the operator is appropriately alert or whether, for example, the operator may be falling asleep. Based upon determining that an operator is not appropriately alert, the system can then take remedial action, such as notifying the operator of the failing alertness, or communicating with a remote location or system (e.g., a remote control room) regarding the operator's deficient alertness.

In some embodiments, such a system can include a radar device configured to detect indicators of one or more biological parameters for an operator. The detected indicators can be processed to determine representative values for the relevant parameters and the representative values can be analyzed to determine if the operator is sufficiently alert. If the operator is determined not to be sufficiently alert, the system can then activate an alarm to help restore the operator's attention (e.g., to startle the operator out of a drowsy state), notify a remote operator or monitoring system of the issue, and record information regarding the incident in an associated memory. This can generally result in improved safety and more efficient operation of the system being manned by the operator.

Certain examples discussed herein address monitoring of operators of commercial vehicles, such as tractor-trailer trucks (herein, generally, “trucks”). However, it will be understood that embodiments the disclosed invention can alternatively (or additionally) be used to monitor operators in other settings, including operators in other transport settings, such as pilots of airplanes, maritime personnel, train conductors, and so on. Similarly, embodiments of the disclosed invention can be used to monitor operators of heavy machinery and other similar equipment (e.g., operators of off-road trucks, mining equipment, construction equipment, container cranes, crawler tractors, agricultural tractors, and so on), as well as operators of non-vehicle commercial and industrial systems (e.g., operators in chemical plants, oil refineries, steel mills and other industrial installations, operators at power plants, operators at military installations, and so on).

Likewise, certain example discussed herein address monitoring of operators for alertness. In some embodiments, other aspects of operator behavior or capabilities can be monitored (e.g., to identify agitation levels or other emotional states).

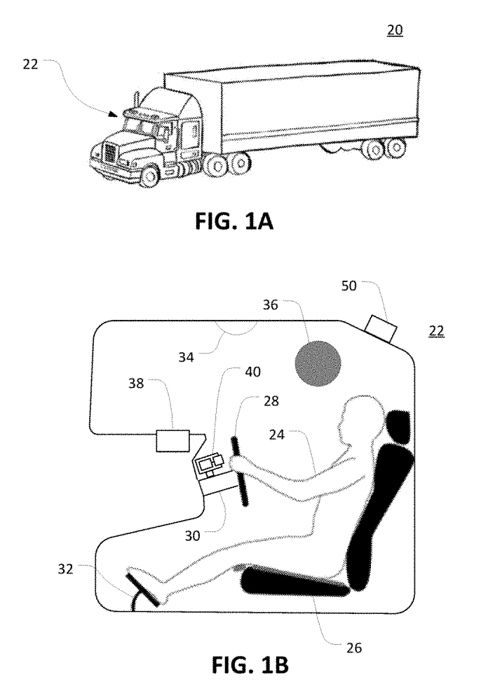

FIG. 1A illustrates an operator setting configured as a truck 20 with a cab 22. Consistent with the discussion above, it will be understood that the truck 20 and the cab 22 are presented as examples only, and that other operator settings, including non-vehicle settings, are also possible.

FIG. 1B illustrates aspects of the interior of the cab 22. Within the cab 22, an operator 24 can sit on a driver's seat 26 disposed to allow operation of a steering wheel 28 supported by a steering column 30, one or more pedals 32, and various other devices (not shown). The cab 22 can also include devices such as a lighting device 34, a speaker 36, and a communication device 38. In the embodiment illustrated, the communication device 38 is a radio communication device, although other configurations are possible.

In accordance with some embodiments of the invention, one or more monitoring devices 40 can be deployed in (or around) the cab 22 in order to monitor biological parameters (e.g., respiration rate and pulse) for the operator 24. The monitoring devices 40 can be deployed at various locations in the cab 22, including, as illustrated, attached to the steering column 30. Generally, the monitoring devices 40 can be disposed in a hemispherical area, with the base of the hemisphere being a plane with a vertical axis approximately aligned with the spine of the operator 24, and a horizontal axis approximately aligned with the shoulders of the operator 24. As such, for example, one or more of the monitoring devices 40 can be disposed in any number of locations that are generally to the front of the seat 26 and that generally range from either lateral side of the cab 22, and from the floor of the cab 22 to the ceiling of the cab 22, including on top of, underneath, or embedded within a dashboard of the cab 22, on or near the steering wheel 28, on or embedded within the ceiling of the cab 22, and so on.

In some embodiments, the monitoring devices 40 can be deployed in other areas. For example, one or more of the monitoring devices 40 can be included in (or attached to) a seat within the cab 22, such as in the back, seating area, bottom, headrest, or other location of a driver's seat of the cab 22. As another example, one or more of the monitoring devices 40 can be included in (or attached to) a seat belt, seat belt buckle, or seat belt buckle receiver within the cab 22. As another example, one or more of the monitoring devices can be included in (or attached to) a rear or side wall of the cab 22, or in (or to) another similarly located feature.

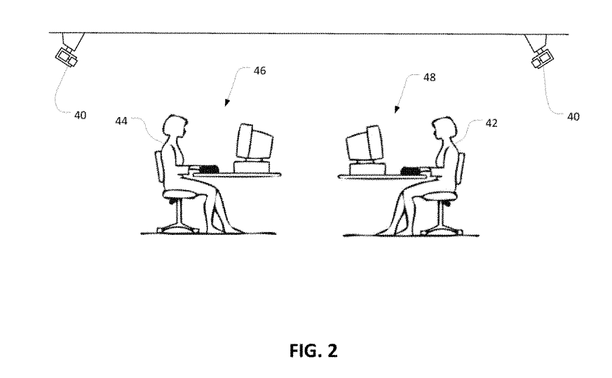

In some embodiments, sets of the monitoring devices 40 can be deployed in arrays. For example, in some embodiments, an array of multiple monitoring devices 40 (not shown) can be arranged within the cab 22 to monitor the operator 24 (and, potentially, other occupants of the cab 22) from different angles. In some embodiments, as illustrated in FIG. 2, an example array of monitoring devices 40 configured for use within a control room can include at least two monitoring devices 40, each disposed to monitor one of two operators 42 and 44 at a respective one of two workstations 46 and 48.

Generally, each of the monitoring devices 40 according to this disclosure can include a sensor for detecting indicators for one or more biological parameters for the relevant operator, an electronic controller (e.g., programmable circuit, general purpose computer, or other computing device), and a communication interface for communicating the detected indicators or other information relating thereto. In some embodiments, the monitoring devices 40 can further include an alarm system. In some embodiments, each of the monitoring devices 40 can be configured as an integral unit that can be moved and installed as a whole. In some embodiments, one or more of the monitoring devices 40 can be configured as a system of modules that can be moved and installed separately.

Referring again to FIG. 1B, in some embodiments, a centralized processing unit 50 (e.g., a centralized electronic controller) can be in communication with the one or more monitoring devices 40 as well as with various other systems of the truck 20 (e.g., the speaker 36, the lighting device 34, and the communication device 38), or other operator setting, in order to activate or otherwise interface with the monitoring device 40 and the various other systems of the truck 20 (e.g., based upon information received from the monitoring devices 40). In some embodiments, one or more of the monitoring devices 40 can be in direct communication with the other systems of the truck (not shown) in order to activate or otherwise interface with those systems based upon information detected or derived by the one or more monitoring devices 40.

In some embodiments, the communication interface of the monitoring device 40 can be configured to communicate with a remotely disposed system. For example, the communication interface of the monitoring device 40 can be configured to communicate using cellular-communication frequencies, in order to communicate with a remote control room or data storage center (not shown). In some embodiments, the communication interface of the monitoring device 40 can be configured to communicate with a communication system of the truck (e.g., the communication device 38), in order to use the communication system of the truck to communicate with a remotely disposed system (e.g., a remote control room or data storage center).

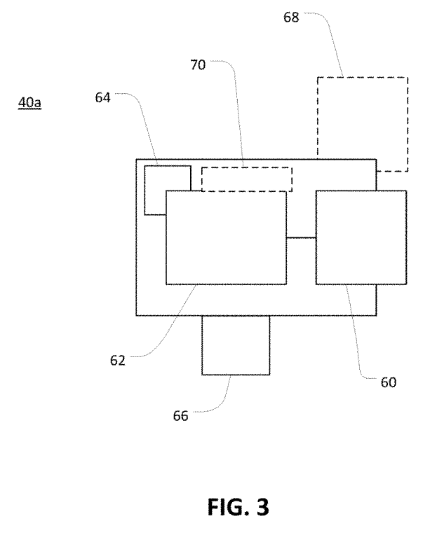

FIG. 3 illustrates a configuration of a monitoring device 40a, according to some embodiments of the invention. In the embodiment illustrated, the monitoring device 40a includes a radar device 60, an electronic controller 62, and a communication interface 64. The radar device 60 can be generally configured to detect indicators relating to biological parameters, such as pulse and respiration rates for an operator, and to relay the indicators to the electronic controller 62 for processing. The electronic controller 62 can process the indicators in various ways including, for example, processing the indicators to extract more useful information regarding the relevant biological parameters (e.g., actual pulse and respiration rates rather than raw or partially-processed signal data), or formatting and/or routing the indicators or related information for transmission by the communication interface 64 to a remotely disposed device (e.g., the processing unit 50 (see FIG. 1B)).

In some embodiments, including as discussed in detail below, the electronic controller 62 can provide local control for a variety of operations for the monitoring device 40a. In some embodiments, the electronic controller 62 can be supplemented (or replaced) by a remotely located electronic controller, such as the processing unit 50 (see FIG. 1B), which can control, supplement, or replace one or more operations of the monitoring device 40a as facilitated by communication via the communication interface 64.

The communication interface 64 can be configured in various ways, depending on the needs of the monitoring device 40a and/or other aspects of the installation setting. In some embodiments, the communication interface 64 can include an antenna for wireless reception and transmission of information. In some embodiments, the communication interface 64 can include a wired (e.g., USB or co-axial cable) interface for non-wireless reception and transmission of information.

In some embodiments, the monitoring device 40a can also include a motive device 66. Generally, the motive device 66 can be configured to move part or all of the monitoring device 40a in a predetermined or otherwise controllable way. For example, in some embodiments, the motive device 66 can be configured to rotate the radar device 60, or the monitoring device 40a as a whole, through a predetermined angular scope, such that the radar device 60 can detect indicators of relevant biological parameters for operators over a distributed area. In some embodiments, the motive device 66 can be configured to provide one-dimensional (“1-D”) movement, such as movement along a 1-D arc. This may be useful, for example, where the monitoring device 40a is to be used in an area in which an operator may not always be located at a fixed position (e.g., a control room with multiple workstations as illustrated in FIG. 2) or where multiple operators may need to be monitored. In some embodiments, the motive device 66 can be configured to provide two-dimensional (“2-D”) movement, such as pivotal movement within a predetermined spherical sector. This may be useful, for example, where the monitoring device 40a is disposed overhead relative to target areas for the relevant operator(s).

In some embodiments, the monitoring device 40a can additionally (or alternatively) include or be configured to interoperate with other monitoring equipment. For example, in some embodiments, the monitoring device 40a can include (or be configured to operate in conjunction with) an imaging device 68. The imaging device 68 can be configured, for example, as a visual, infrared, 3D or other camera with an overlapping field of view with the radar device 60.

As also noted above, the radar device 60 generally can be configured to detect indicators of one or more biological parameters. For example, the radar device 60 can be configured to detect movements of an operator that correspond to pulse and/or respiration rate. In some embodiments, the radar device 60 can be configured to itself derive a pulse and/or respiration rate (or other biological parameter) from such indicators. In some embodiments, the radar device 60 can provide data from detected indicators to a separate processing device (e.g., the electronic controller 62 or the processing unit 50), and the separate processing device can derive the respiration rate (or other biological parameter) from the indicators.

In different embodiments, the radar device 60 can take a variety of different forms and can employ a variety of different technologies. In some embodiments, for example, the radar device can be configured to use continuous wave radar (e.g. a continuous wave Doppler radar) a microwave radar (e.g., microwave Doppler radar), or other suitable radar can be used.

In various embodiments, as disclosed above, a continuous wave radar in the microwave wavelength range (a microwave Doppler radar) may be used. The continuous wave radar may be uniquely advantageous to performing the system and method herein over known technologies.

There are several known methods for detecting vital signs using electromagnetic radiation (e.g. radar). The most common methods are associated with radar using either pulsed or continuous wave (CW) systems. The pulse forms are designed using ultra wide band (UWB) because the pulse is Gaussian amplitude shape with very short duration, typically in the nanosecond range. The time between transmit and receive is then measured, called time of flight (TOF). Recently the return pulse is processed assuming multiple reflections are possible, which gives more information but also can give a more confusing picture of what the radiation is bouncing off of.

The CW system more closely resembles an interferometer. These systems are described in the book “Theory, Analysis and Design of RF Interferometric Sensors” by Cam Nguyen and Seoktae Kim, Springer 2012. The advantage of an interferometer over a pulsed TOF system (for example, a UWB system) is in the resolution of the change in motion of the target. The CW system is accurate to fractions of a wavelength because it is continuous. The TOF system can only be as accurate as its time base. While it is possible to build exceptionally accurate time systems, they are much more expensive than a simple RF interferometer.

The disclosed system may further use a self-injection locking method to facilitate obtaining and identifying the data using a radar system disclosed herein. The self-injection locking (SIL) method has additional advantages over the standard interferometer. With the normal CW Doppler system any constant return signals causes a DC offset in the output. This is called “clutter” in normal radar texts. If there is enough clutter, the DC offset can overwhelm the base band operational amplifiers so that no useful signal is actually detected. In the SIL radar, the clutter creates a frequency offset. The process of converting the signal to baseband uses an FM demodulator so that this offset is removed and only the change in motion is left.

An advantage of the standard CW radar interferometer is its simplicity. If clutter is not an issue within a specific environment CW radar is perfectly well suited to do the job. It is far cheaper than UWB systems and can measure to better resolution.

Therefore, the disclosed system and method may advantageously obtain certain data using a continuous wave radar, for example, a microwave Doppler radar. Use of this system may allow for various advantages over systems using pulse forms such as UWB radar systems. These advantages may include enhanced accuracy, simplicity, cost effectiveness, and better resolution.

In some embodiments, the radar device 60 can be configured to monitor a fixed area (e.g., a field of view of part of the cab 22 with a fixed angular range). In some embodiments, the radar device 60 can monitor a range of areas, including, for example, via sweeping through a predetermined 1-D or 2-D angular range. Various technologies can be employed to allow the radar device 60 to sweep through a range, including servo motors or other mechanical-motion technologies (e.g., as provided by the motive device 66), phased array technologies, meta-materials, and so on. In some embodiments, including with regard to monitoring the control room of FIG. 2, multiple instances of the monitoring device 40, with corresponding multiple instances of the radar device 60, can be used in combination to monitor different (e.g., exclusive or overlapping) areas, including via fixed-area or swept-area monitoring.

As also noted above, the monitoring devices 40 (e.g., configured as illustrated for the monitoring device 40a) can be deployed at different areas and in different relative configurations relative to an expected location or locations of an operator or operators. In some embodiments, the monitoring devices 40 can be deployed to monitor locations in which operators are likely to remain, such as a driver's seat of a vehicle or other machine, or locations corresponding to controls for a relevant system (e.g., different consoles within a control room).

In some embodiments, it may be useful to arrange the monitoring devices 40 in arrays relative to each other. For example, in some embodiments, two monitoring devices 40 can be deployed on opposite sides of a shared target area. This can be useful, for example, in helping to eliminate unwanted artifacts (e.g., from large-scale operator movements) from relevant monitored indicators. As another example, multiple monitoring devices 40 can be deployed to cover respective overlapping or non-overlapping regions, such that the monitoring devices 40 can collectively monitor relatively large areas. This may be useful, for example, to allow the monitoring devices 40 to monitor multiple consoles within a control room, or multiple control panels for a vehicle or piece of equipment.

In some embodiments, aspects of deployment for the monitoring devices 40 can depend on the type of radar device (e.g., the type of the radar device 60) employed by the monitoring devices 40. For example, where the radar device 60 (or the monitoring device 40a, generally) is configured to scan over a 1-D or 2-D area, it may be possible for the monitoring device 40a to replace multiple other monitoring devices 40. For example, it may be possible to replace an array of multiple monitoring devices 40 monitoring multiple consoles in a control room with a smaller number of monitoring devices 40 (e.g., the single monitoring device 40a) that can scan over a 1-D or 2-D angular range that covers an appropriate portion (e.g., all or most) of the control room.

In some embodiments, it may be useful to utilized different radar frequencies at different monitoring devices 40 (or at different radar devices included in a single monitoring device 40). This can be useful for example, to help to prevent various monitoring devices 40 in an array (or various radar devices in a single monitoring device 40) from interfering with each other. For example, where a first and a second monitoring device 40 are deployed with overlapping scanning ranges (e.g., overlapping 1-D arc segments, each focused on a different workstation of a control room, as illustrated in FIG. 2), it may be useful for the first monitoring device 40 to utilize a first radar frequency and for the second monitoring device 40 to utilize a second radar frequency that is different from the first radar frequency.

In some embodiments, the monitoring devices 40 may be relatively portable. As such, for example, the monitoring devices 40 can be fixed in particular locations as desired (e.g., via semi-permanent attachment to support structures of the cab 22), but then may be re-located as appropriate. In some embodiments, for example, monitoring of system performance (e.g., via the processing unit 50) may indicate that a monitoring device 40 (or array of monitoring devices 40) at a particular location or orientation tends to provide relatively useful data, while a monitoring device 40 (or array of monitoring devices 40) at another location (or orientation) tends to provide less useful data. The processing unit 50 can accordingly recommend (e.g., via a user interface (not shown)) that the second monitoring device 40 be relocated or reoriented.

In some embodiments, touch-less monitoring via the monitoring devices 40 (e.g., via the radar device 60 of the monitoring device 40a) can proceed in combination with monitoring via other technologies. As also noted above, for example, the monitoring device 40a can include the imaging device 68 (see FIG. 2), such as a visual, infrared, 3-D or other camera with an overlapping field of view with the radar device 60. In some embodiments, the imaging device 68 can be used to identify bulk operator movements (e.g., bulk movement of an operator's head or other body parts) which can be used to supplement analysis conducted with the relevant indicators of biological parameters that are monitored by the monitoring device 40.

One or more monitoring devices 40, individually or collectively, can be configured to detect indicators relating to a variety of different biological parameters. In some embodiments, as also discussed above, the monitoring devices 40 can be configured to detect indicators relating to pulse and respiration rate. For example, with regard to the monitoring device 40a, the radar device 60 can be configured to detect minute operator movements corresponding to pulse and respiration rate. Monitoring of other indicators may also (or alternatively) be possible, including indicators relating to larger scale movements, such as nodding of an operator's head, as may indicate a lack of alertness.

In some embodiments, the monitoring devices 40 can internally process detected indicators in order to determine relevant biological parameters. For example, once indicators of movements relating to pulse or respiration rate are detected by the radar device 60, the electronic controller 62 (or the radar device 60 itself) can process the indicators to determine the actual pulse or respiration rate of the monitored operator.

In some embodiments, the monitoring devices 40 can transmit detected indicators to external systems for identification of relevant biological parameters. For example, once indicators of movements relating to pulse and respiration rate are detected by the radar device 60, data representing those indicators can be transmitted to the processing unit 50 by the communication interface 64. The processing unit 50 can then process the indicators (via the transmitted data) to determine the relevant pulse and respiration rate.

In some embodiments, indicators relating to monitored parameters, monitored parameters themselves, or other data, can be stored by or for various of the monitoring devices 40. For example, the monitoring device 40a can sometimes include a storage device 70 (e.g., a flash storage device) configured to record parameters relating to the monitoring of an operator (e.g., data relating to pulse and respiration rate, environmental or system conditions or status, operator actions, and so on). This can be useful, for example, in order to establish a temporal record relating to the alertness of the operator. In some embodiments, parameters relating to the monitoring of an operator can be stored remotely (e.g., after being communicated to a remote system via the communication interface 64).

In some embodiments, parameters other than those relating to pulse and respiration rate can also be monitored and, in some cases, recorded. For example, in addition to monitoring (and recording) pulse and respiration rates for an operator over time, the monitoring device 40 (or related other devices) can be configured to monitor and/or record environmental information for the cab 22 or other setting (e.g., temperature, humidity, operational status of various equipment within the cab 22 management equipment, and so on), or external environmental information (e.g., ambient temperature, humidity and other weather factors outside of the cab 22 or other setting, as well as other external information (e.g., information relating to proximate traffic patterns, road conditions or rules, and so on). As appropriate, these additional parameters can be analyzed in conjunction with the relevant biological parameters (e.g., pulse and respiration rates) in order to more effectively monitor operator alertness as well as to understand (e.g., via subsequent statistical analysis) potential causes of any lapses in operator alertness.

Once appropriate biological parameters (e.g., pulse and respiration rate) have been determined, the monitoring device 40 (or a remote controller, such as the processing unit 50) can process the parameters to determine a level of alertness for an operator. In some embodiments, the system can look for patterns that may indicate a lack of alertness or an incipient lack of alertness. For example, as an operator moves from a fully awake state towards REM sleep the pulse and respiration rates of the operator may both tend to measurably decrease. Accordingly, when the monitoring device 40 detects a decrease in pulse and respiration rates of a particular operator, the monitoring device 40 may determine that the operator is not sufficiently alert. Further, as an operator approaches (or reaches) REM sleep, pulse and respiration rates typically stabilize as compared to more variable pulse and respiration when the operator is fully awake. Accordingly, a temporal analysis of the stability of pulse and respiration rates can be used to identify an operator slipping towards and eventually reaching REM sleep, with corresponding implications for operator alertness.

Once a lack of alertness (or other depressed alertness level) for an operator has been determined, appropriate remedial actions can then be executed. For example, an alarm can be sounded to rouse the operator (e.g., using the speaker 36 or the communication device 38), a visual signal can be provided to rouse the operator (e.g., using the lighting device 34), or an alert can be communicated to a remote monitoring station (e.g., using the communication device 38 and/or the communication interface 64). In some embodiments, the monitoring device 40 can itself imitate and/or execute the appropriate remedial action. For example, the monitoring device 40 can cause the speaker 36 (or an embedded speaker (not shown)) to sound an alarm, can cause a notification to be transmitted to a remote monitoring station (e.g., using the communication interface 64) and so on. In some embodiments, separate systems or devices can initiate and/or execute the appropriate remedial action. For example, a signal can be sent from a remote monitoring station causing an alarm to sound or a visual indicator to display within the cab 22.

In some embodiments, factors other than biological parameters can be considered in determining whether to monitor an operator or whether an operator may be insufficiently alert. For example, monitoring of alertness by the monitoring device 40 can be activated based on whether the ignition of the truck 20 has been turned on or off (e.g., such that the monitoring device 40 is only active when the ignition is on), based on the status of a transmission of the truck 20 (e.g., such that the monitoring is only active when the truck 20 is in a drive gear), based upon the presence or absence of operator in the cab 22 (e.g., such that the monitoring device 40 is only active when weight or other sensors indicate that the operator 24 is in the driver's seat 26) and so on.

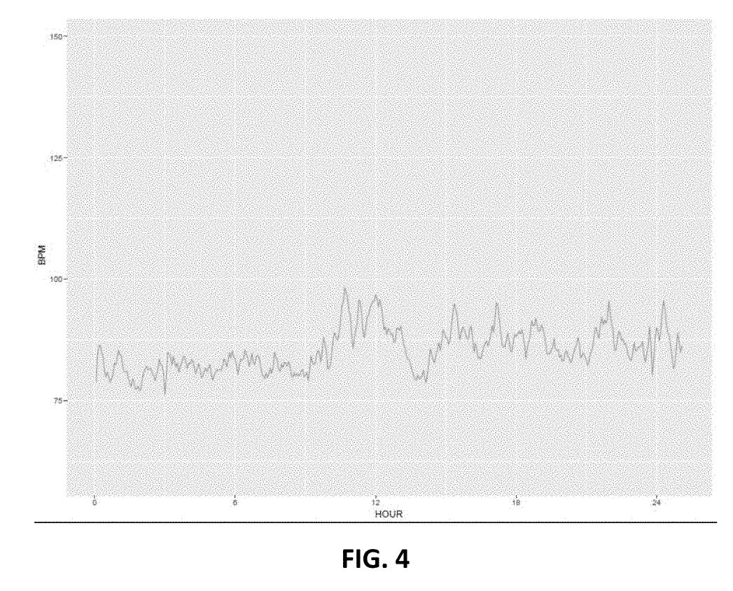

FIG. 4 shows a graph of test data. The test data shows a graph relating pulse and fatigue. The data was collected from a number of drivers over the course of several hours across a number of days. Pulse readings were made of the drivers over those periods of time. As can be seen, by tracking a driver's pulse, predictions can be made as to whether a driver is fatigued. For example, after 1800 hours (6 PM, shown as “18 hours”) the driver's pulse may be seen to be on a trajectory downward, this change, which is amplified when correlated with respiration monitoring, may allow for identification of a fatigued state in the driver. This may allow for the system to issue warnings that continuing to drive is not safe. In this example, when the pulse and respiration is some percentage off of the midday highs a warning may be issued to the driver and/or the carrier that the vehicle is entering an unsafe condition due to driver fatigue.

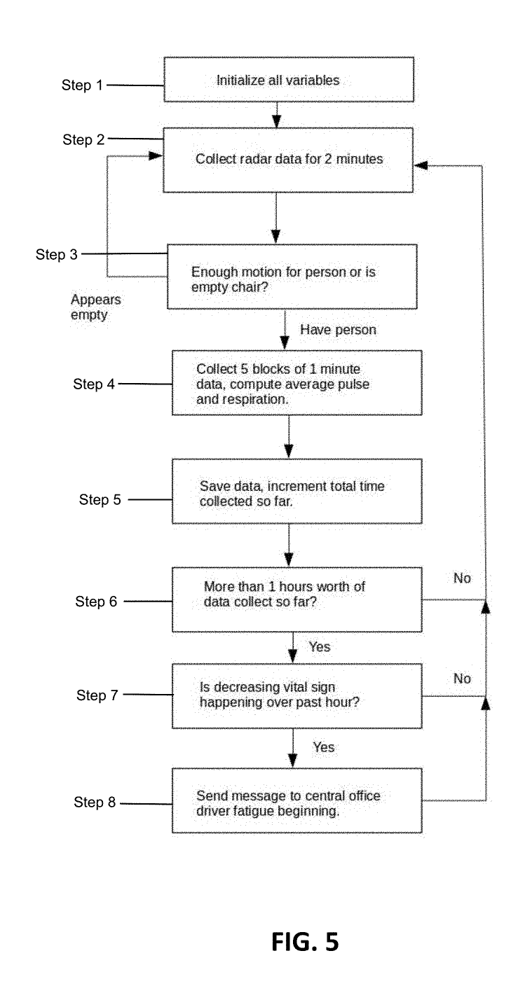

FIG. 5 is an algorithm for performing the system and method herein. In a first step, all system variables are initialized including start time, zero number of minutes collected, reset buffer pointers, etc. Initial measurements are performed in Step 2, where radar data may be collected for a certain period of time. In various embodiments, this period is two minutes (though more or less time should be understood as within the scope of this disclosure). Next, in Step 3, the system may evaluate whether there is sufficient motion indicated by the data to indicate the presence of a person in the chair. In various embodiments, the person in the chair may be the driver in a driver's seat of a vehicle. If the chair appears empty, the system may continue to collect radar data until a person is indicated by the data.

In Step 4, the sensor may collect a number of sets of data over a period of time. These sets may be used to compute an average pulse and respiration. The number of sets of data may be five sets or blocks of data (though more or less sets, for example, any number suitable for computation, may be contemplated as within the scope of this disclosure). The period of time for each data block may be one minute. These samples may be obtained using a continuous wave radar sensor or other method described herein. After the data sets or blocks are collected, an average pulse and respiration may be calculated.

In Step 5, the data may be saved and a total time of collection may be incremented. In Step 6, the system may evaluate whether or not a total time of data collection has met a certain threshold. In various embodiments, the total time may be one hour, though other time periods may be contemplated as within the scope of this disclosure. If the time threshold has not been met, the system may continue to acquire data. If the time threshold has been met, in Step 7, the system may evaluate whether a decreasing vital sign has been occurring over the past hour. If not, the system may continue monitoring. If a vital sign is decreasing, the system may send a message regarding driver fatigue in Step 8. In various embodiments, the message may be sent to a central office that a driver fatigue condition is occurring.

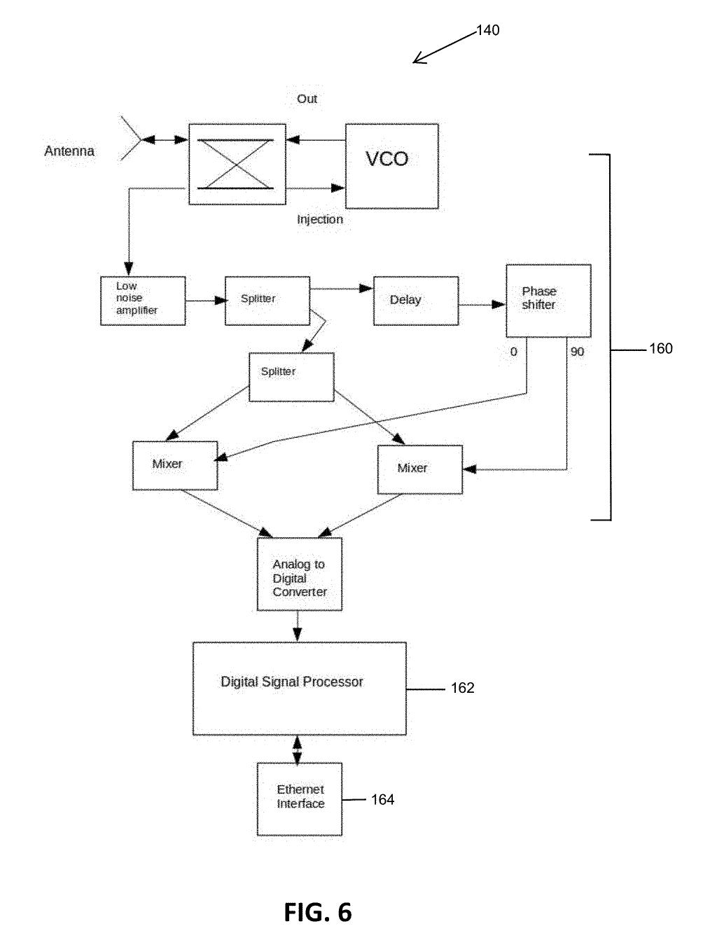

FIG. 6 is a schematic for a device for performing the system and method herein. A number of components may be provided within the device. The device 140 may include a signal processor 162 and a radar device or system 160. The system may also include a networking mechanism such as an Ethernet interface 164.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

As indicated, in one or more examples of embodiments the system and/or method may be implemented by a processing unit, a microcontroller, or a computer system, or in combination with a computer system. The computer system may be or include a processor. The computers may be electronic devices for use with the methods and various components described herein and may be programmable computers which may be special purpose computers or general purpose computers that execute the system according to the relevant instructions. The computer system or portable electronic device can be an embedded system, a personal computer, notebook computer, server computer, mainframe, networked computer, workstation, handheld computer, as well as now known or future developed mobile devices, such as for example, a personal digital assistant, cell phone, smartphone, tablet computer, and the like. Other computer system configurations are also contemplated for use with the communication system including, but not limited to, multiprocessor systems, microprocessor-based or programmable electronics, network personal computers, minicomputers, smart watches, and the like. Preferably, the computing system chosen includes a processor suitable in size to efficiently operate one or more of the various systems or functions or attributes of the system described.

The system or portions thereof may also be linked to a distributed computing environment, where tasks are performed by remote processing devices that are linked through a communication network(s). To this end, the system may be configured or linked to multiple computers in a network including, but not limited to, a local area network, wide area network, wireless network, and the Internet. Therefore, information, content, and data may be transferred within the network or system by wireless means, by hardwire connection, or combinations thereof. Accordingly, the servers described herein communicate according to now known or future developed pathways including, but not limited to, wired, wireless, and fiber-optic channels.

Data, for example, sensor data or recommendations, may be sent or submitted via the Internet, wireless, and fiber-optic communication network(s), or created or stored on a particular device. In one or more examples of embodiments, data may be stored remotely or may be stored locally on the user's device or controller. In one example, data may be stored locally in files. Data may be stored and transmitted by and within the system in any suitable form. Any source code or other language suitable for accomplishing the desired functions described herein may be acceptable for use.

Furthermore, the computer or computers or portable electronic devices may be operatively or functionally connected to one or more mass storage devices, such as but not limited to, a database. The memory storage can be volatile or non-volatile, and can include removable storage media. Cloud-based storage may also be acceptable. The system may also include computer-readable media, which may include any computer-readable media or medium that may be used to carry or store desired program code that may be accessed by a computer. The invention can also be embodied as computer-readable code on a computer-readable medium. To this end, the computer-readable medium may be any data storage device that can store data which can be thereafter read by a computer system. Examples of computer-readable medium include read-only memory, random-access memory, CD-ROM, CD-R, CD-RW, magnetic tapes, flash drives, as well as other optical data storage devices. The computer-readable medium can also be distributed over a network-coupled computer system so that the computer-readable code is stored and executed in a distributed fashion.

A display (not shown) may be provided for display of data. To this end, a display or screen may be provided as part of the system. The display or screen may be a tablet or mobile computing device. The display may be positioned where one or more users may observe the display.

Additionally, information may be stored in the system such that data can be used to provide feedback. In various embodiments, data may be stored in a device in communication with the display, computing device, mobile device, or other suitable location.

Some portions of the detailed descriptions herein are presented in terms of procedures, steps, logic blocks, processing, and other symbolic representations of operations on data bits that can be performed on computer memory. These descriptions and representations are the means used by those skilled in the data-processing arts to most effectively convey the substance of their work to others skilled in the art. A procedure, computer-executed step, logic block, process, etc. is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It should be borne in mind; however, that all of these and similar terms are to be associated with the appropriate physical quantities and are merely convenient labels applied to these quantities. Unless specifically stated otherwise as apparent from the discussions herein, it is appreciated that throughout the present invention, discussions utilizing terms, such as “receiving,” “sending,” “generating,” “reading,” “invoking,” “selecting,” and the like, refer to the action and processes of a computer system, or similar electronic computing device, including an embedded system, that manipulates and transforms data represented as physical (electronic) quantities within a suitable computer system.

The technical effects and technical problems in the specification are exemplary and are not limiting. It should be noted that the embodiments described in the specification may have other technical effects and can solve other technical problems.

1. A system for monitoring alertness of an operator, the system comprising:
at least one continuous wave radar device configured to detect an indicator of a biological parameter for the operator; and
one or more controllers in communication with the radar device and configured to:
determine a value for the biological parameter based upon the detected indicator; and
determine a level of alertness of the operator based upon the determined value for the biological parameter.

2. The system of claim 1, wherein the biological parameter includes at least one of a respiration rate and a pulse.

3. The system of claim 2, wherein determining the level of alertness includes identifying a decrease in the at least one of the respiration rate and the pulse.

4. The system of claim 2, wherein determining the level of alertness includes identifying a transition of the at least one of the respiration rate and the pulse from an initial more-variable pattern to a subsequent less-variable pattern.

5. The system of claim 2, wherein the one or more controllers are further configured to initiate a remedial action based upon the determined level of alertness.

6. The system of claim 5, wherein the remedial action includes at least one of sounding an alarm, activating a visual indicator, and communicating with a remotely located control system.

7. The system of claim 1, wherein the at least one radar device includes a plurality of radar devices distributed at a plurality of locations relative to the operator.

8. The system of claim 1, wherein the system is configured to monitor alertness of a plurality of operators.

9. The system of claim 8, wherein the at least one radar device includes a first radar device configured to monitor alertness of a first operator and a second radar device configured to monitor alertness of a second operator.

10. The system of claim 1, wherein the operator operates a vehicle and the at least one radar device is disposed within a cab of the vehicle.

11. The system of claim 1, wherein the operator operates at least one workstation of a control room and the at least one radar device is disposed within the control room.

12. The system of claim 1, wherein the operator operates at least one of an airplane, a maritime vessel, and heavy machinery.

13. A method for monitoring alertness of an operator, the method comprising:
detecting, with at least one radar device, an indicator of a biological parameter for the operator
determining, with one or more computing devices, a value for the biological parameter based upon the detected indicator; and
determining, with the one or more computing devices, a level of alertness of the operator based upon the determined value for the biological parameter.

14. The method of claim 12, wherein the biological parameter includes at least one of a respiration rate and a pulse.

15. The method of claim 14, wherein determining the level of alertness includes identifying a decrease in the at least one of the respiration rate and the pulse.

16. The method of claim 14, wherein determining the level of alertness includes identifying a transition of the at least one of the respiration rate and the pulse from an initial more-variable pattern to a subsequent less-variable pattern.

17. The method of claim 14, further comprising:
initiating a remedial action based upon the determined level of alertness.

18. The method of claim 17, wherein the remedial action includes at least one of sounding an alarm, activating a visual indicator, and communicating with a remotely located control method.

19. The method of claim 13, wherein the at least one radar device includes a plurality of radar devices distributed at a plurality of locations relative to the operator.

20. The method of claim 13, further comprising:
detecting indicators of biological parameters for multiple operators; and
determining a level of alertness of the multiple operators.

21. The method of claim 20, wherein the at least one radar device includes a first radar device configured to monitor alertness of a first operator and a second radar device configured to monitor alertness of a second operator.

22. The method of claim 13, wherein the operator operates a vehicle and the at least one radar device is disposed within a cab of the vehicle.

23. The method of claim 13, wherein the operator operates at least one workstation of a control room and the at least one radar device is disposed within the control room.

24. The method of claim 13, wherein the operator operates at least one of an airplane, a maritime vessel, and heavy machinery.

25. A monitoring device for touch-less monitoring of alertness of an operator, the monitoring device comprising:
at least one radar device configured to detect an indicator of a biological parameter for the operator;
a communication interface in communication with one or more systems external to the monitoring device; and
one or more controllers in communication with the radar device and the communication interface;
the one or more controllers being configured to:
determine a value for the biological parameter based upon the detected indicator; and
determine a level of alertness of the operator based upon the determined value for the biological parameter.

26. The monitoring device of claim 25, wherein the biological parameter includes at least one of a respiration rate and a pulse.

27. The monitoring device of claim 26, wherein determining the level of alertness includes identifying a decrease in the at least one of the respiration rate and the pulse.

28. The monitoring device of claim 26, wherein determining the level of alertness includes identifying a transition of the at least one of the respiration rate and the pulse from an initial more-variable pattern to a subsequent less-variable pattern.

29. The monitoring device of claim 26, wherein the one or more controllers are further configured to initiate a remedial action based upon the determined level of alertness.

30. The monitoring device of claim 29, wherein the remedial action includes at least one of sounding an alarm, activating a visual indicator, and communicating with a remotely located control monitoring device.

31. The monitoring device of claim 25, wherein the at least one radar device includes a plurality of radar devices distributed at a plurality of locations relative to the operator.

32. The monitoring device of claim 25, wherein the monitoring device is configured to monitor alertness of a plurality of operators.

33. The monitoring device of claim 32, wherein the at least one radar device includes a first radar device configured to monitor alertness of a first operator and a second radar device configured to monitor alertness of a second operator.

34. The monitoring device of claim 25, wherein the operator operates a vehicle and the at least one radar device is disposed within a cab of the vehicle.

35. The monitoring device of claim 25, wherein the operator operates at least one workstation of a control room and the at least one radar device is disposed within the control room.

36. The monitoring device of claim 25, wherein the operator operates at least one of an airplane, a maritime vessel, and heavy machinery.
